(19) United States
(12) Patent Application Publication
(10) Pub. No.: US 2011/0090419 A1
(43) Pub. Date: Apr. 21, 2011

(54) ELECTROOPTICAL DEVICE AND ELECTRONIC DEVICE

(75) Inventor: Osamu YOKOYAMA, Shiojiri-shi (JP)

(73) Assignee: SEIKO EPSON CORPORATION, Tokyo (JP)

(21) Appl. No.: 12/904,517

(22) Filed: Oct. 14, 2010

(30) Foreign Application Priority Data
Oct. 16, 2009 (JP) 2009-239174

(51) Int. Cl. G02F 1/1335; G02B 27/10

(52) U.S. Cl. 349/57; 359/619

(57) ABSTRACT

An electrooptical device includes a display element having a plurality of pixels, a lenticular lens which is arranged at a view side of the display element and spatially separates the pixels, and an observation optical system which is arranged at the view side with respect to the lenticular lens. An image of the pixels by the lenticular lens is formed between the observation optical system and a front focal point of the observation optical system.

### BACKGROUND

1. Technical Field

The present invention relates to an electrooptical device and an electronic device.

2. Related Art

In a stereoscopic virtual image display device which displays a virtual image of an image displayed on a display panel in a distance and in which the displayed virtual image is observed, a configuration in which a parallax barrier is arranged on a front surface of the display panel and left and right images are divided is disclosed (see, JP-A-7-287193). However, if the parallax barrier is arranged, light absorbed or shut-out is increased. Therefore, a display image becomes dark. Further, since the parallax barrier does not have a refractive force, a position and magnification of the virtual image of the display panel has been determined based only on a positional relationship between a focal distance of an observation lens or an observation mirror and the display panel.

Then, as means for improving a light use efficiency and displaying a bright stereoscopic virtual image, a configuration in which a lenticular lens is arranged on a front surface of the display panel instead of the parallax barrier has been proposed (see, JP-A-7-270722 and JP-A-9-105885). When the lenticular lens is used for dividing parallax images to left and right, the lenticular lens having a refractive force is arranged in addition to the observation lens or the observation mirror. Therefore, a position of a virtual image formed by the observation lens or the observation mirror is made different depending on a position of the display panel (pixels) arranged with respect to a focal position of the lenticular lens.

However, in JP-A-7-270722 and JP-A-9-105885, a position of pixels with respect to a focal point of the lenticular lens is not disclosed. However, the pixels can be estimated to be at a position closer to the lenticular lens than to the focal point of the lenticular lens because light output from the lenticular lens is divergent light in FIG. 2 in JP-A-7-270722. However, unless an image of pixels generated by the lenticular lens is at the side of the observation lens or the observation mirror with respect to a focal position of the observation lens or the observation mirror, a virtual image cannot be observed.

Accordingly, in the existing configurations, there has arisen the following problem. That is, a position of pixels with respect to a focal point of a lenticular lens, and a relationship between a position of an image of pixels by the lenticular lens and a focal position of an observation lens or an observation mirror are not defined in the existing configurations. Therefore, an optical condition for observing a virtual image generated at a predetermined distance before user's eyes is not clear.

### SUMMARY

An advantage of some aspects of the invention is to provide an electrooptical device and an electronic device of which sizes are reduced and which can display a bright stereoscopic virtual image with high display quality while suppressing distortion by defining an imaging specification of the lenticular lens.

An electrooptical device according to an aspect of the invention includes a display element having a plurality of pixels, a lenticular lens which is arranged at a view side of the display element and spatially separates the pixels, and an observation optical system which is arranged at the view side with respect to the lenticular lens. In the electrooptical device, an image of the pixels by the lenticular lens is formed between the observation optical system and a front focal point of the observation optical system.

According to the aspect of the invention, an image of pixels of the display element by the lenticular lens is formed between the observation optical system and a focal position at the front side of the observation optical system. Therefore, a bright stereoscopic virtual image with high display quality while suppressing distortion can be displayed.

Further, it is preferable that the pixels be positioned between the lenticular lens and a front focal point of the lenticular lens.

In the aspect of the invention, pixels are positioned between the lenticular lens and a focal point of the lenticular lens. Therefore, a virtual image of the pixels is formed by the lenticular lens. The virtual image of the pixels is formed at the side of the observation optical system with respect to the front focal point of the observation optical system. Therefore, a virtual image of the virtual image is formed by the observation optical system. Thus, when a virtual image of the pixels is formed by the lenticular lens, variation in magnification of an image relating to variation in position of the pixels is made smaller than that in a configuration in which a real image of pixels is formed by the lenticular lens. Accordingly, a stereoscopic virtual image having less distortion can be obtained.

Further, it is preferable that a front focal point of the lenticular lens be positioned between the lenticular lens and the pixels.

In the aspect of the invention, a front focal point of the lenticular lens is positioned between the lenticular lens and the pixels. Therefore, a real image of pixels is formed by the lenticular lens and the real image of the pixels is at the side of the observation optical system with respect to a front focal point of the observation optical system. Accordingly, a virtual image of the real image is formed by the observation optical system.

Further, it is preferable that the observation optical system be an optical system having a convex lens effect.

According to the aspect of the invention, the observation optical system is an optical system having a convex lens effect so that an optical system can be configured so as to be symmetric with respect to an optical axis. Therefore, a stereoscopic virtual image having less distortion can be obtained.

Further, it is preferable that magnification of the lenticular lens be equal to or lower than 2×.

According to the aspect of the invention, magnification of the lenticular lens is equal to or lower than 2×. Therefore, a small-sized observation lens or a small-sized observation mirror can be employed. As a result, a stereoscopic virtual image having less distortion can be obtained while reducing the device in size.

Further, it is preferable that the display element include a liquid crystal panel in which a pair of substrates sandwiches an electrooptical layer therebetween, and a pair of polarization plates each of which is arranged each outer surface side of the liquid crystal panel, and the lenticular lens be arranged between one of the substrates and one of the polarization plates which are arranged at a view side on the display element.

According to the aspect of the invention, the lenticular lens is arranged between the liquid crystal display of the display elements and one of the polarization plates. Therefore, a space between the pixels of the liquid crystal panel and the lenticular lens can be made smaller. This makes it possible to appropriately separate view point images for stereoscopic display and to form a stereoscopic virtual image which is easily recognized.

Further, it is preferable that the electronic device include the electrooptical device according to the aspect of the invention.

According to the aspect of the invention, the electronic device includes the electrooptical device described above. Therefore, an electronic device by which a bright stereoscopic virtual image with high display quality can be displayed while suppressing distortion is obtained.

### BRIEF DESCRIPTION OF THE DRAWINGS

The invention will be described with reference to the accompanying drawings, wherein like numbers reference like elements.

FIGS. 1A and 1B are plan views illustrating a configuration of an electrooptical device according to a first embodiment.

FIG. 2 is a descriptive view illustrating an optical system of the electrooptical device.

FIG. 3 is a descriptive view illustrating a basic optical system of a display device for observation of a virtual image.

FIG. 4 is a view illustrating an optical arrangement of pixels, a lenticular lens and an observation lens.

FIG. 5 is a descriptive view illustrating an optical system of an electrooptical device according to a second embodiment.

FIG. 6 is a schematic configuration view illustrating a head-up display which is an example of an electronic device.

FIG. 7 is a view of an image of the head-up display, which is seen from driver's seat of a vehicle.

### DESCRIPTION OF EXEMPLARY EMBODIMENTS

Hereinafter, embodiments of the invention will be described with reference to drawings. Note that in the drawings used for the following description, the scale of each member is appropriately changed in order to make each member understood easily.

### First Embodiment

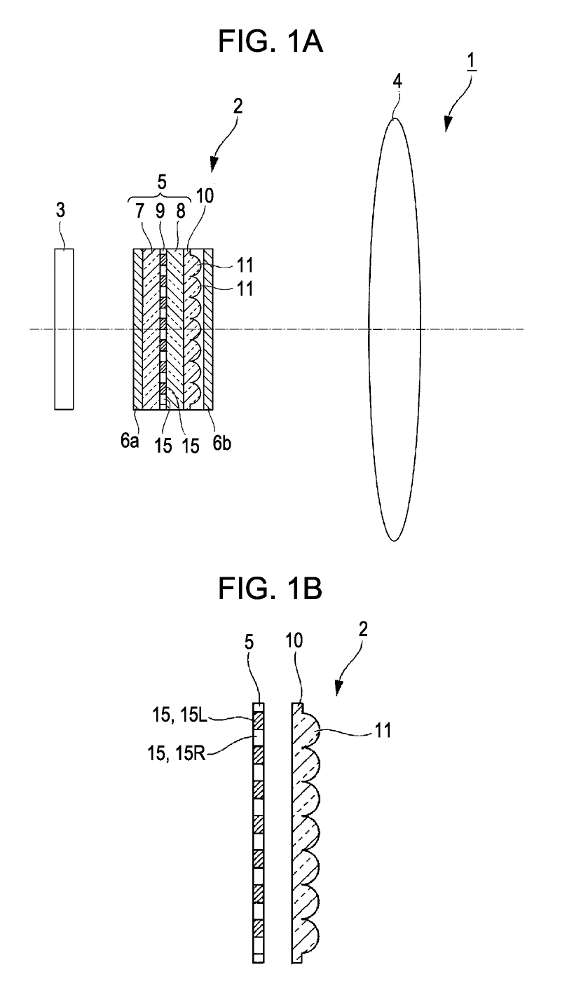

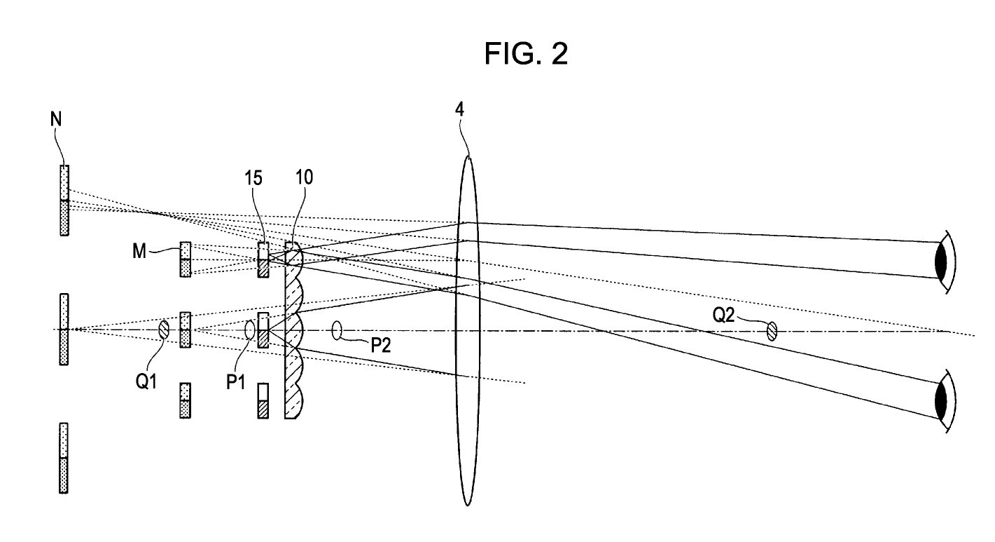

FIG. 1A is a view illustrating a schematic configuration of an electrooptical device 1 according to an embodiment of the invention. FIG. 1B is an enlarged view illustrating essential parts of a liquid crystal panel and a lenticular lens. FIG. 2 is a descriptive view illustrating an optical system of the electrooptical device 1.

As shown in FIG. 1A, the electrooptical device 1 according to the embodiment includes an optical modulation display element 2, an illumination device 3, and an observation lens 4 (observation optical system). The illumination device 3 is arranged at a rear face side of the optical modulation display element 2 and illuminates the optical modulation display element 2. The observation lens (observation optical system) focuses an optical image formed in the optical modulation display element 2 onto eyes of an observer.

The optical modulation display element 2 is an active matrix type transmissive display device including a liquid crystal panel 5. The optical modulation display element 2 is configured of the liquid crystal panel 5, a pair of polarization plates 6a, 6b and a lenticular lens 10.

The liquid crystal panel 5 is formed by holding a liquid crystal layer 9 between a pair of transparent glass substrates 7, 8. A pixel electrode, a switching element and the like which are not shown are formed at the side of the liquid crystal layer 9 on the light incident side glass substrate 7. As shown in FIG. 1B, pixels 15L for a left eye and pixels 15R for a right eye are alternately arranged on each row in a display region. An image for left eye is formed by the pixel rows for the left eye and an image for the right eye is formed by the pixel rows for the right eye so that an observer recognizes stereoscopic video with parallax between the image for the left eye and the image for the right eye. Size of the display region on the liquid crystal panel 5 used in the embodiment is 2 inches in diagonal.

The lenticular lens 10 is arranged at an outer surface side (view side) of the light outgoing side glass substrate 8 of the liquid crystal panel 5.

The lenticular lens 10 has a function of imaging an image formed by each pixel 15 of the liquid crystal panel 5 on a space. The lenticular lens 10 is formed into a stripe form by arranging a plurality of semi-cylindrical-shaped convex lenses 11 so as to be in parallel with each other. Each convex lens 11 is arranged so as to correspond to two pixels (pixel for right eye and pixel for left eye) of the liquid crystal panel 5 as shown in FIG. 1B. A pitch thereof is set to be slightly larger than a pitch of two pixels of the liquid crystal panel 5. The configuration is needed for forming a stereoscopic virtual image in a distance by the observation lens. The lenticular lens 10 having such configuration is attached to an outer surface of the light outgoing side glass substrate 8 of the liquid crystal panel 5 in order to make a space smaller between the lenticular lens 10 and the pixels 15 of the liquid crystal panel 5.

The pair of polarization plates 6a, 6b are arranged at a light incident side and a light outgoing side of the liquid crystal panel 5, respectively. In this case, the light outgoing side polarization plate 6b is arranged at an outer side (observer side) of the lenticular lens 10 and cooperates with the light outgoing side glass substrate 8 of the liquid crystal panel 5 in sandwiching the lenticular lens 10 therebetween.

The observation lens 4 is a magnifying optical system formed with a bi-convex lens in which a curved surface of the lens acts as a refracting surface. The observation lens 4 magnifies and displays a virtual image formed by the lenticular lens 10. It is to be noted that as the observation lens 4, a Fresnel lens or a lens system formed with a plurality of lenses for enhancing resolution of an image or suppressing distortion can be used.

In such a configuration, a light flux emitted from each pixel 15 of the liquid crystal panel 5 reaches each of the left eye L and the right eye R of an observer with a spatial separation effect of the lenticular lens 10. Therefore, the observer observes a virtual image N (which is a magnified virtual image of a virtual image M formed by the lenticular lens) of the pixels 15 through the observation lens 4. That is to say, the observer at an appropriate view position recognizes video for the left eye by observing the pixels 15L for the left eye and recognizes video for the right eye by observing the pixels 15R for the right eye, thereby recognizing magnified stereoscopic video with the binocular parallax.

In the electrooptical device 1 according to the embodiment, the pixels 15 of the liquid crystal panel 5 are positioned at the side of the lenticular lens 10 with respect to a front focal point P1 of the lenticular lens 10 as shown in FIG. 2. That is to say, the pixels 15 (liquid crystal panel 5) are positioned between the lenticular lens 10 and the front focal point P1 thereof. Further, virtual images M of the pixels 15, which are formed by the lenticular lens 10, are formed at the side of the observation lens 4 with respect to a front focal point Q1 of the observation lens 4. Therefore, virtual images N of the virtual images M are formed at positions which are distanced from the observer's eyes by the observation lens 4.

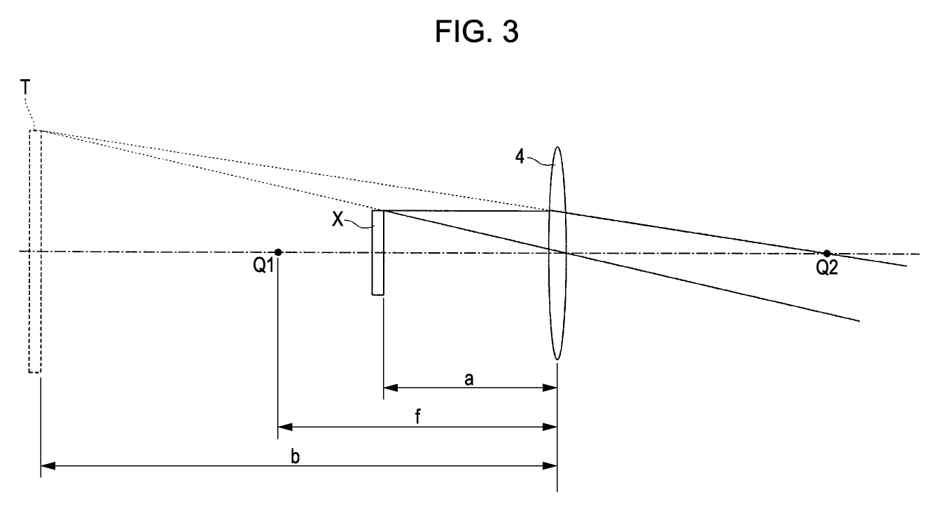

Here, a basic optical system of a display device for observation of a virtual image is described with reference to FIG. 3.

As shown in FIG. 3, a distance from the observation lens 4 to a position of an image X which is desired to be seen is assumed to be “a” and a distance from the observation lens 4 to the front focal point Q1 thereof is assumed to be “f”. A virtual image T of the image X which is desired to be seen is formed at a position farther from the observation lens 4 than the front focal point Q1 of the observation lens 4. If a>0, b<0 and 1/f=(1/a+1/b) are assumed to be satisfied, magnification m of the virtual image obtained by the observation lens 4 with respect to the image X which is desired to be seen is b/a.

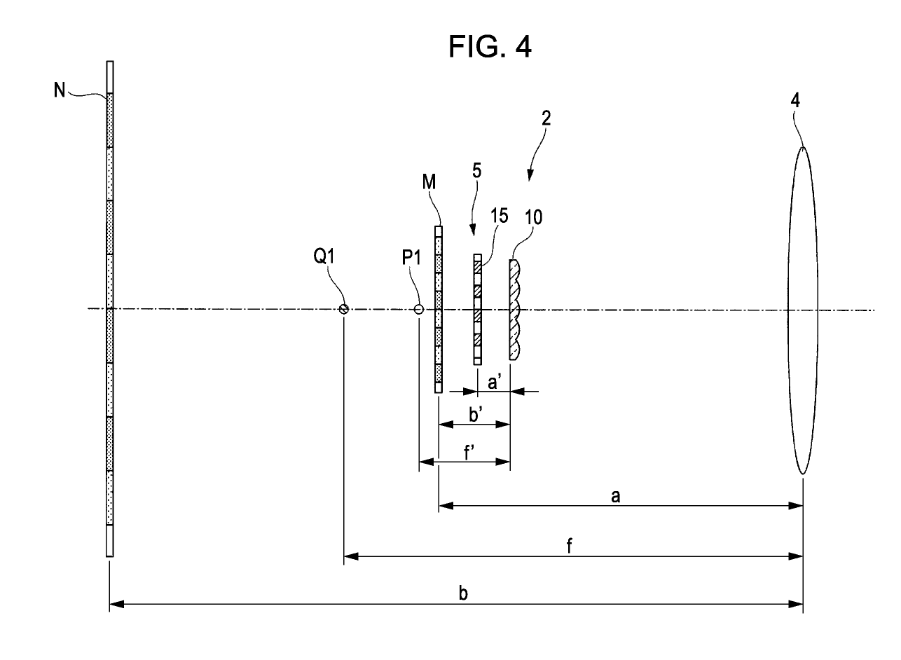

Next, a specific configuration in the electrooptical device 1 according to the embodiment is described. In FIG. 4, an optical arrangement of the pixels, the lenticular lens 10 and the observation lens 4 is illustrated. At this time, a distance from the observation lens 4 to the virtual image M of the pixels 15 formed by the lenticular lens 10 is assumed to be “a”. A distance from the observation lens 4 to the front focal point Q1 thereof is assumed to be “f”. Then, the magnification m of the virtual image N with respect to the virtual image M obtained by the lenticular lens 10 is b/a.

It is to be noted that glass substrates, polarization plates and the like of the liquid crystal panel 5 are not shown because the arrangement is represented in air-equivalent distance. Further, the position of the liquid crystal panel 5 is defined while setting the position of the pixels as the center.

In the embodiment as shown in FIG. 4, a distance “a′” from the pixels to the lenticular lens 10 is approximately 0.23 mm and a focal distance “f′” of the lenticular lens 10 is approximately 0.5 mm. The pixels 15 are positioned at the side of the lenticular lens 10 with respect to the front focal point P1 of the lenticular lens 10. Accordingly, an image of the pixels 15 is a virtual image M by the lenticular lens 10 and a distance “b′” between the virtual image M and the lenticular lens 10 is approximately 0.42 mm. It is to be noted that the magnification of the virtual image M with respect to the pixels 15 is approximately 1.8×.

The focal distance “f” of the observation lens 4 is assumed to be 400 mm and the distance “a” from the virtual image of the pixels by the lenticular lens 10 to the observation lens 4 is assumed to be approximately 350 mm. Then, the virtual image M of the pixels 15 by the lenticular lens 10 is at the side of the observation lens 4 with respect to the front focal point Q1 of the observation lens 4. Accordingly, the virtual image M of the pixels 15 by the lenticular lens 10 becomes a virtual image N by the observation lens 4 so that a distance “b” from the virtual image N to the observation lens 4 is approximately 2800 mm.

Accordingly, when the liquid crystal panel 5 having the lenticular lens 10 is observed from a rear side of the observation lens 4, the magnified virtual image N can be seen at a position of 2.8 m ahead of the observation lens 4.

Further, an image having parallax is generated by the lenticular lens 10 so that parallax is also generated on a virtual image seen through the observation lens 4, thereby recognizing a stereoscopic image.

### Second Embodiment

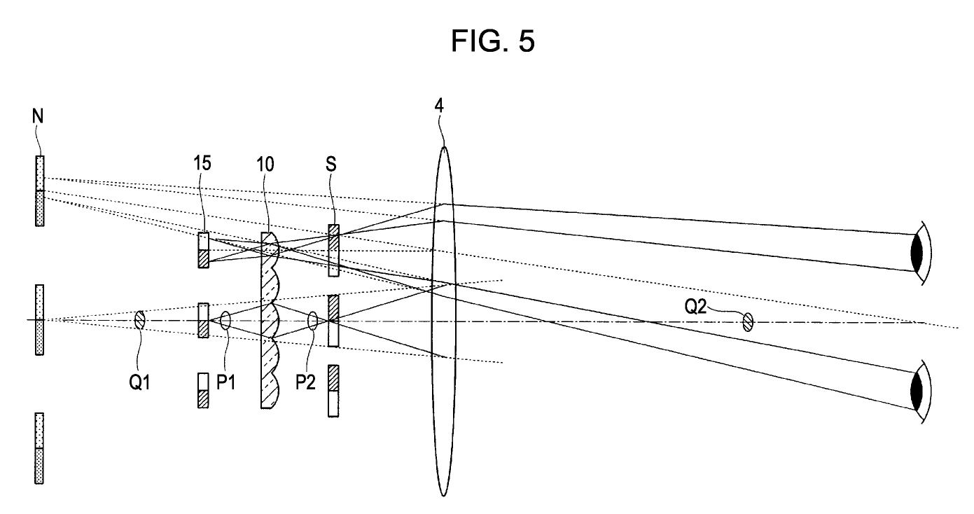

In the first embodiment, a configuration of the electrooptical device using the optical system in which a virtual image of pixels is once formed and the virtual image is displayed in a distance as a magnified virtual image by the observation lens 4 has been described. However, in the second embodiment, an electrooptical device including an optical system in which the lenticular lens 10 once forms a real image of pixels and the real image is displayed in a distance as a magnified virtual image by the observation lens 4 is described. It is to be noted that a basic configuration of the electrooptical device according to the second embodiment is substantially the same as that according to the first embodiment. However, a position of the liquid crystal panel 5 (pixels) with respect to the lenticular lens 10 in the second embodiment is different from that in the first embodiment. FIG. 5 is a descriptive view illustrating the optical system of the electrooptical device according to the second embodiment.

An electrooptical device 20 as shown in FIG. 5 has a configuration in which the pixels 15 of the liquid crystal panel 5 are positioned farther from the lenticular lens 10 than the front focal point P1 of the lenticular lens 10. That is to say, the front focal point P1 of the lenticular lens 10 is positioned between the pixels 15 and the lenticular lens 10.

In this case, real images S (images inverted by an effect of the lenticular lens 10) of the pixels 15 are formed by the lenticular lens 10. Further, the real images S of the pixels 15 are at the side of the observation lens 4 with respect to the front focal point Q1 of the observation lens 4. Therefore, the virtual images N of the real images S of the pixels 15 are formed at positions distanced from observer's eyes by the observation lens 4.

According to the embodiment, the real images S of the pixels 15, which are formed by the lenticular lens 10, are formed at the side of the observation lens 4 with respect to the focal point of the observation lens 4. With this configuration, the virtual images N of the real images S of the pixels 15 can be observed.

However, variation in the magnification of the images relative to variation in the position of the pixels 15 is smaller in the configuration in which the virtual images M of the pixels 15 are formed by the lenticular lens 10 as in the above-described first embodiment. Therefore, the configuration in which the virtual images M of the pixels 15 are formed by the lenticular lens 10 is more preferable.

In a common autostereoscopic display device using the lenticular lens 10, an image of pixels is formed at an observation position into a size of an average width between eyes (about 65 mm). Therefore, if the size of the pixel is assumed to be 50 μm, the magnification by the lenticular lens 10 is approximately 1300×.

As in the above first and second embodiments, in the display device in which the virtual image or the real image of the pixels 15 is obtained as a magnified virtual image through the observation lens 4, the magnification of the virtual image or the real image of the pixels 15 by the lenticular lens 10 is desired to be equal to or lower than 2×. When the image is magnified to be too large by the lenticular lens 10, resolution of the image by the lenticular lens 10 is lowered and resolution of the virtual image generated by the observation lens 4 is also lowered. Further, when the magnification of the virtual image generated by the lenticular lens 10 is too high, distortion of the image such as distortion by the observation lens 4 is significantly caused so that a configuration of the observation optical system is made complicated in order to suppress the distortion.

On the other hand, in the embodiment, the magnification by the lenticular lens 10 is suppressed to be low. Therefore, a configuration of the observation optical system is not required to be complicated and a small-sized observation lens 4 can be used. This makes it possible to reduce the entire device in size.

Thus, a position of the pixels with respect to a focal point of the lenticular lens 10, and a relationship between a position of an image of the pixels by the lenticular lens 10 and a focal position of the observation lens 4 are defined to make an optical condition for observing a virtual image generated at a predetermined distance before the user's eyes clear. With this, a stereoscopic image with high display quality can be obtained. Further, the lenticular lens 10 is used in order to generate parallax for stereoscopic display without using a parallax barrier. Therefore, a bright stereoscopic image can be observed.

In the embodiment, a bi-convex lens is used as the observation lens 4. Therefore, an optical system which is symmetric with respect to an optical axis can be configured so that a stereoscopic virtual image having less image distortion can be obtained.

It is to be noted that a concave mirror can be employed instead of the bi-convex lens. An embodiment of an electronic device including an electrooptical device which includes the concave mirror as the observation optical system is described below.

### Electronic Device

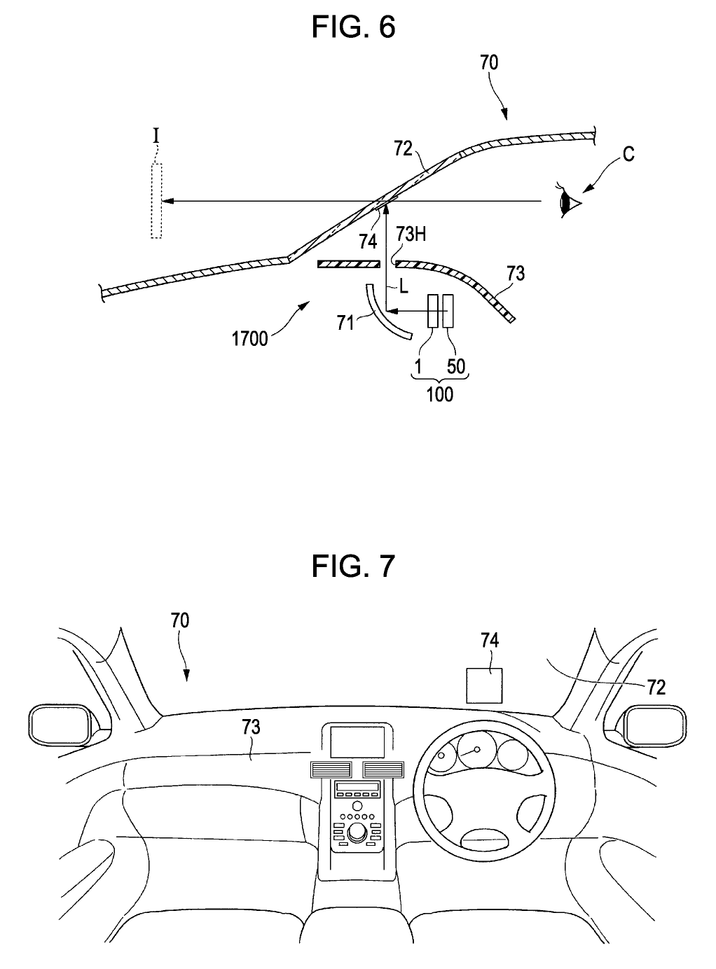

FIG. 6 is a schematic configuration view illustrating a head-up display 1700 as an embodiment of the electronic device. FIG. 7 is a view of an image of the head-up display 1700, which is seen from a driver's seat of a vehicle.

In FIG. 6, a vehicle 70 is a sedan type passenger car. The head-up display 1700 includes an electrooptical device 100, a concave mirror (observation optical system) 71 and a half mirror 74. The concave mirror 71 projects light L (image light) output from the electrooptical device 100 onto a windshield 72. The half mirror 74 reflects light projected onto the windshield 72 toward the driver's seat.

The electrooptical device 100 is accommodated within a dashboard 73. In the dashboard 73, an opening 73H for transmitting the light L is provided below the windshield 72 and the light L reflected by the concave mirror 71 is projected onto the half mirror 74 through the opening 73H. The projected image is visually recognized as a virtual image I by a driver C in the vehicle.

The half mirror 74 is formed into a sheet-like film, for example. The half mirror 74 may be formed so as to reflect a part of the light L by processing a surface of the windshield 72. As shown in FIG. 7, the half mirror 74 is arranged in front of the driver's seat. Pieces of information including a speed meter, remaining quantity of gasoline, alarm, and the like are displayed on the half mirror 74. The driver C can recognize the pieces of information without the need for largely moving his/her line of sight while driving.

Further, since the electrooptical device 100 is installed in a small dashboard 73, a small-sized display device with high definition, which causes less heat, is desired as the electrooptical device 100. The electrooptical device 100 according to the embodiment realizes high definition and high light use efficiency by using a lenticular lens without using a parallax barrier. Therefore, the electrooptical device 100 according to the embodiment has the most appropriate configuration as the head-up display. Further, the electronic device including the small-sized electrooptical device can be also reduced in size so that a space where the electronic device is mounted in the vehicle 70 can be easily secured.

Preferred embodiments according to the invention have been described above with reference to the accompanying drawings. However, it is needless to say that the invention is not limited to the above embodiments. As would be understood by one skilled in the art, it is obvious that various changes and modifications can be made within a range of technical ideas described in Claims and the changes and modifications are encompassed in the technical range of the invention.

For example, the electrooptical display device according to the invention can be applied not only to the head-up display but also to a head-mount display. Further, display elements other than the liquid crystal panel can be applied to the display element.

The entire disclosure of Japanese Patent Application No. 2009-239174, filed Oct. 16, 2009 is expressly incorporated by reference herein.

What is claimed is:

1. An electrooptical device comprising:
a display element having a plurality of pixels;
a lenticular lens which is arranged at a view side of the display element and spatially separates the pixels; and
an observation optical system which is arranged at the view side with respect to the lenticular lens,
wherein an image of the pixels by the lenticular lens is formed between the observation optical system and a front focal point of the observation optical system.

2. The electrooptical device according to claim 1,
wherein the pixels are positioned between the lenticular lens and a front focal point of the lenticular lens.

3. The electrooptical device according to claim 1,
wherein a front focal point of the lenticular lens is positioned between the lenticular lens and the pixels.

4. The electrooptical device according to claim 1,
wherein the observation optical system is an optical system having a convex lens effect.

5. The electrooptical device according to claim 1,
wherein magnification of the lenticular lens is equal to or lower than 2×.

6. The electrooptical device according to claim 1,
wherein the display element includes:
a liquid crystal panel in which a pair of substrates sandwiches an electrooptical layer therebetween;
a pair of polarization plates each of which is arranged each outer surface side of the liquid crystal panel, and
the lenticular lens is arranged between one of the substrates and one of the polarization plates which are arranged at a view side of the display element.

7. An electronic device comprising:
an electrooptical device that includes:
a display element having a plurality of pixels;
a lenticular lens which is arranged at a view side of the display element and spatially separates the pixels; and
an observation optical system which is arranged at the view side with respect to the lenticular lens,
wherein an image of the pixels by the lenticular lens is formed between the observation optical system and a front focal point of the observation optical system.

8. The electronic device according to claim 7,
wherein the pixels are positioned between the lenticular lens and a front focal point of the lenticular lens.

9. The electronic device according to claim 7,
wherein a front focal point of the lenticular lens is positioned between the lenticular lens and the pixels.

10. The electronic device according to claim 7,
wherein the observation optical system is an optical system having a convex lens effect.

11. The electronic device according to claim 7,
wherein magnification of the lenticular lens is equal to or lower than 2×.

12. The electronic device according to claim 7,
wherein the display element includes:
a liquid crystal panel in which a pair of substrates sandwiches an electrooptical layer therebetween;
a pair of polarization plates each of which is arranged each outer surface side of the liquid crystal panel, and
the lenticular lens is arranged between one of the substrates and one of the polarization plates which are arranged at a view side of the display element.
